(19) United States
(12) Patent Application Publication
(10) Pub. No.: US 2023/0049958 A1
(43) Pub. Date: Feb. 16, 2023

(54) ULTRA-LOW VISCOSITY ETHYLENE-BUTENE COPOLYMER AND COMPOSITION FOR HOT-MELT ADHESIVE INCLUDING THE SAME

(71) Applicant: SABIC SK NEXLENE COMPANY PTE. LTD., Singapore (SG)

(72) Inventors: Min Ho JEON, Daejeon (KR); Sang Bae CHEONG, Daejeon (KR); Choon Sik SHIM, Daejeon (KR); Ji Eun KIM, Daejeon (KR); Ji Hyun BAE, Daejeon (KR); Seon Mi SHIN, Daejeon (KR); Dae Ho SHIN, Daejeon (KR)

(21) Appl. No.: 17/758,875

(22) PCT Filed: Jan. 7, 2021
(86) PCT No.: PCT/IB2021/050080

§ 371 Date: Jul. 14, 2022

(30) Foreign Application Priority Data
Jan. 15, 2020 (KR) 10-2020-0005144

(51) Int. Cl. C08F 210/16; C08F 2/06; C09J 123/08

(52) U.S. Cl. CPC C08F 210/16; C08F 2/06; C09J 123/0815

(57) ABSTRACT

Provided are an ultra-low viscosity ethylene-butene copolymer which is a copolymer derived from ethylene and butene, wherein the ethylene-butene copolymer has a density of 0.874 to 0.900 g/cm³ and a melting point of 63 to 90° C., and a composition for a hot-melt adhesive including the same. The ethylene-butene copolymer according to the present disclosure may be rapidly melted at a certain melting point or higher and may provide a low processing temperature with a significantly low viscosity. In addition, the composition for a hot-melt adhesive according to the present disclosure includes the ethylene-butene copolymer, thereby having excellent thermal resistance with high shear adhesion failure temperature and peel adhesion failure temperature and securing both excellent cohesiveness and adhesive strength.

### TECHNICAL FIELD

The present disclosure relates to an ultra-low viscosity ethylene-butene copolymer and a composition for a hot-melt adhesive including the same.

### BACKGROUND AND SUMMARY

A hot-melt adhesive (HMA) is usually in a solid state at room temperature, and is heated to be in a melted state and then cooled and solidified on an adherend, a substrate, or the like to form an adhesive layer. The hot-melt adhesive as described above has an excellent instant adhesive property, is widely used in various fields such as product assembly and packaging, and has many commercial application examples used in paper products, packaging materials, disposable products, and the like.

In addition, the physical properties of the hot-melt adhesive are largely dependent on cohesiveness and adhesive strength of a base resin. Thus, conventionally, it was intended to increase cohesiveness and adhesive strength by providing a high molecular weight resin as the base resin, but result in a high viscosity increase, and such a high viscosity hot-melt adhesive requires a high processing temperature which causes decomposition, carbonization, gelation, or adhesive strength loss of the adhesive. Thus, at the high processing temperature, productivity is deteriorated, a safety risk occurs, and deformation and discoloration of an adherend or a substrate are caused.

In order to solve the problems, conventionally, a study of decreasing a content of the base resin to lower the viscosity of the hot-melt adhesive was conducted, but in this case, the adhesive has low cohesiveness and adhesive strength and the softening point may be excessively lowered. In addition, a plasticizer is excessively used in this case and it could cause a phase separation with the base resin and a bleeding phenomenon.

Moreover, as the conventionally provided base resin, various resins such as olefin-based or styrene-based resins were used, but has been replaced with an ethylene-alpha olefin copolymer having no odor and excellent flowability. However, the conventionally provided ethylene-alpha olefin copolymer has excellent adhesive strength but significantly low cohesiveness.

Thus, development of a base resin which may secure both excellent cohesiveness and adhesive strength as a hot-melt adhesive is urgently needed.

### DISCLOSURE

### Technical Problem

An object of the present disclosure is to provide an ultra-low viscosity ethylene-butene copolymer having a low processing temperature.

Another object of the present disclosure is to provide an ultra-low viscosity ethylene-butene copolymer which may have better thermal resistance than an ethylene-octene copolymer. Still another object of the present disclosure is to provide a composition for a hot-melt adhesive including an ultra-low viscosity ethylene-butene copolymer which may secure both excellent cohesiveness and adhesive strength.

### Technical Solution

In one general aspect, an ultra-low viscosity ethylene-butene copolymer is a copolymer derived from ethylene and butene, wherein the ethylene-butene copolymer has a density of 0.874 to 0.900 g/cm³ and a melting point of 63 to 90° C.

The ultra-low viscosity ethylene-butene copolymer according to an exemplary embodiment of the present disclosure may have a viscosity of 6,000 to 20,000 cP as measured at 177° C.

The ultra-low viscosity ethylene-butene copolymer according to an exemplary embodiment of the present disclosure may be prepared by solution polymerization in the presence of a single active site metallocene catalyst.

The ultra-low viscosity ethylene-butene copolymer according to an exemplary embodiment of the present disclosure may have a weight average molecular weight of 15,000 to 30,000 g/mol.

The ultra-low viscosity ethylene-butene copolymer according to an exemplary embodiment of the present disclosure may have a shear adhesion failure temperature (SAFT) of 70° C. or higher.

The ultra-low viscosity ethylene-butene copolymer according to an exemplary embodiment of the present disclosure may have a butene content of 10 to 30 wt %.

The ultra-low viscosity ethylene-butene copolymer according to an exemplary embodiment of the present disclosure may be for a hot-melt adhesive.

In another general aspect, a composition for a hot-melt adhesive includes: an ultra-low viscosity ethylene-butene copolymer having a density of 0.874 to 0.900 g/cm³ and a melting point of 63 to 90° C., a tackifier, and a wax.

The composition for a hot-melt adhesive according to an exemplary embodiment of the present disclosure may include 25 to 50 wt % of the ultra-low viscosity ethylene-butene copolymer, 20 to 45 wt % of the tackifier, and 20 to 40 wt % of the wax.

The ultra-low viscosity ethylene-butene copolymer of the composition for a hot-melt adhesive according to an exemplary embodiment of the present disclosure may have a viscosity of 6,000 to 20,000 cP as measured at 177° C.

The ultra-low viscosity ethylene-butene copolymer of the composition for a hot-melt adhesive according to an exemplary embodiment of the present disclosure may be prepared by solution polymerization in the presence of a single active site metallocene catalyst.

The ultra-low viscosity ethylene-butene copolymer of the composition for a hot-melt adhesive according to an exemplary embodiment of the present disclosure may have a butene content of 10 to 30 wt %.

The composition for a hot-melt adhesive according to an exemplary embodiment of the present disclosure may further include an antioxidant.

The composition for a hot-melt adhesive according to an exemplary embodiment of the present disclosure may have a shear adhesion failure temperature (SAFT) of 95° C. or higher and a peel adhesion failure temperature (PAFT) of 45° C. or higher.

The composition for a hot-melt adhesive according to an exemplary embodiment of the present disclosure may satisfy the following Relations 1 and 2:

Tₐ−T_{c}≥24 Relation 1

T_{b}−T_{c}≥−24 Relation 2

wherein

Tₐ is a shear adhesion failure temperature (° C.) of the composition for a hot-melt adhesive, T_{b} is a peel adhesion failure temperature (° C.) of the composition for a hot-melt adhesive, and T_{c} is a melting point (° C.) of the ultra-low viscosity ethylene-butene copolymer.

### BEST MODE

Hereinafter, the present disclosure will be described in more detail with reference to specific examples and exemplary embodiments including the accompanying drawings. However, the following specific examples or exemplary embodiments are only a reference for describing the present disclosure in detail, and the present disclosure is not limited thereto, and may be implemented in various forms.

In addition, unless otherwise defined, all technical terms and scientific terms have the same meanings as those commonly understood by a person skilled in the art to which the present disclosure pertains. The terms used herein are only for effectively describing a certain specific example, and are not intended to limit the present disclosure.

Throughout the present specification describing the present disclosure, unless explicitly described to the contrary, “comprising” any elements will be understood to imply further inclusion of other elements rather than the exclusion of any other elements.

In addition, the singular form used in the specification may be intended to also include a plural form, unless otherwise indicated in the context.

The present disclosure for achieving the above object relates to an ultra-low viscosity ethylene-butene copolymer and a composition for a hot-melt adhesive including the same.

Hereinafter, the present disclosure will be described in detail.

The ultra-low viscosity ethylene-butene copolymer according to the present disclosure is a copolymer derived from ethylene and butene, wherein the ethylene-butene copolymer has a density of 0.874 to 0.900 g/cm³ and a melting point of 63 to 90° C.

The ultra-low viscosity ethylene-butene copolymer according to the present invent disclosure ion may satisfy the density and the melting point, thereby securing excellent thermal resistance.

More specifically, the ultra-low viscosity ethylene-butene copolymer according to the present disclosure represents a low melting point as compared with the conventional ethylene-octene copolymer having the same density, and when a composition for a hot-melt adhesive including the ultra-low viscosity ethylene-butene copolymer is provided, high shear adhesion failure temperature and peel adhesion failure temperature are implemented to secure excellent thermal resistance.

According to an exemplary embodiment of the present disclosure, the ultra-low viscosity ethylene-butene copolymer may have a density of 0.874 to 0.895 g/cm³ and a melting point of 63 to 90° C. In some embodiments, the density may be 0.875 to 0.890 g/cm³ and the melting point may be 64 to 80° C., or the density may be 0.880 to 0.890 g/cm³ and the melting point may be 70 to 80° C. By satisfying both the density and the melting point as described above, the ultra-low viscosity ethylene-butene copolymer may be used at a low processing temperature and have excellent shear adhesion failure temperature and peel adhesion failure temperature to have significantly excellent adhesive strength and cohesiveness.

According to an exemplary embodiment of the present disclosure, the ultra-low viscosity ethylene-butene copolymer may be specifically an ethylene-1-butene copolymer, and as an example, may be a random copolymer, a block copolymer, or an alternating copolymer, but is not limited thereto.

According to an exemplary embodiment of the present disclosure, the ultra-low viscosity ethylene-butene copolymer may have a viscosity of 6,000 to 20.000 cP as measured at 177° C. with a Brookfield viscometer. In some embodiments, the viscosity may be 6,000 to 18,000 cP as measured at 177° C. By having such a low viscosity, the ultra-low viscosity ethylene-butene copolymer may be melted at a low processing temperature, and when provided as a hot-melt adhesive composition, decomposition, carbonation, gelation, adhesive strength loss, and the like may be prevented.

According to an exemplary embodiment of the present disclosure, the ultra-low viscosity ethylene-butene copolymer may have a butene content of 10 to 30 wt %. In some embodiments, the butene content may be 10 to 28 wt %. As described above, by having the butene content, excellent thermal resistance may be secured and excellent adhesiveness with a substrate may be provided as a hot-melt adhesive.

According to an exemplary embodiment of the present disclosure, the ultra-low viscosity ethylene-butene copolymer may have a number average molecular weight (Mn) of 10,000 to 20,000 g/mol. In some embodiments, the number average molecular weight may be 10,000 to 15,000g/mol.

According to an exemplary embodiment of the present disclosure, the ultra-low viscosity ethylene-butene copolymer may have a weight average molecular weight (Mw) of 15,000 to 30,000 g/mol. In some embodiments, the weight average molecular weight may be 15,000 to 27,000g/mol, or the weight average molecular weight may be 18,000 to 27,000 g/mol.

According to an exemplary embodiment of the present disclosure, the ultra-low viscosity ethylene-butene copolymer may have a molecular weight distribution (Mw/Mn) of 1.5 to 3.0. In some embodiments, the molecular weight distribution (Mw/Mn) may be 1.8 to 2.5.

According to an exemplary embodiment of the present disclosure, the ultra-low viscosity ethylene-butene copolymer may have a Melt index of 400 to 800 g/10 min, or 440 to 700 g/10 min as measured at 190° C. with a load of 2.16 kg in accordance with ASTM D1238.

In the case of having the molecular weight, the molecular weight distribution, and the Melt index as described above, the ultra-low viscosity ethylene-butene copolymer may be provided, and in spite of the low melting point, when the ultra-low viscosity ethylene-butene copolymer is included with a tackifier and a wax in the composition for a hot-melt adhesive, significantly raised shear adhesion failure temperature and peel adhesion failure temperature may be implemented.

According to an exemplary embodiment of the present disclosure, the ultra-low viscosity ethylene-butene copolymer may be prepared by contacting a catalyst, a cocatalyst, ethylene, and butene in the presence of an appropriate organic solvent. Here, the catalyst and cocatalyst components may be added to a reactor separately, or each component may be mixed previously and added to a reactor, and mixing conditions such as an addition order, a temperature, or concentration are not particularly limited.

According to an exemplary embodiment of the present disclosure, the organic solvent may be for example, C3-C20 hydrocarbon, and for instance any one or a mixed solvent of two or more selected from butane, isobutane, pentane, hexane, heptane, octane, isooctane, nonane, decane, dodecane, cyclohexane, methylcyclohexane, benzene, toluene, xylene, and the like.

According to an exemplary embodiment, the ultra-low viscosity ethylene-butene copolymer may be polymerized in the presence of a single active site metallocene catalyst as the catalyst. The single active site metallocene catalyst is a homogeneous catalyst having a single catalytic active site, and may produce an ethylene-based copolymer having a narrow molecular weight distribution and being uniform as compared with a Ziegler-Natta catalyst. In addition, the ultra-low viscosity ethylene-butene copolymer is polymerized under the single active site metallocene catalyst, thereby producing a copolymer which may satisfy the melting point and the density desired in the present disclosure. Thus, the physical properties desired in the present disclosure may be achieved.

Specifically, the single active site metallocene catalyst is a transition metal catalyst, and may be a transition metal compound including indene or a derivative thereof having a structure in which a Group 4 transition metal in the periodic table as a center metal has a rigid plane structure, electrons are abundant and widely delocalized, and a nitrogen-containing substituent and a silyl group are connected by a substituted amido group.

In addition, according to an exemplary embodiment of the present disclosure, since the single active site metallocene catalyst is present in a homogeneous form in a polymerization reactor, it is preferred to apply the catalyst to a solution polymerization process which is carried out at a temperature equal to or higher than a melting point of the polymer.

More specifically, the single active site metallocene catalyst may be a transition metal compound represented by the following Chemical Formula 1:

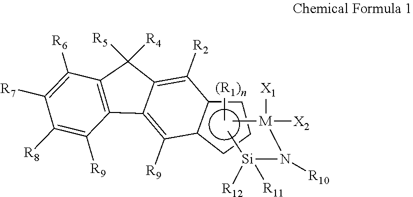

wherein M is a Group 4 transition metal in the periodic table;

n is an integer of 1 or 2, and when n is 2, R₁ may be identical to or different from each other;

R₁ is hydrogen, (C1-C50)alkyl, halo(C1-C50)alkyl, (C3-C50)cycloalkyl, (C6-C30)aryl, (C6-C30)ar(C1-C50)alkyl, ((C1-C50)alkyl(C6-C30)aryl)(C1-C50)alkyl, —NR^{a}R^{b}, —SiR^{c}R^{d}R^{e}, or 5 to 7-membered N-heterocycloalkyl containing one or more nitrogen atoms;

R₂ and R₃ are independently of each other hydrogen, (C1-C50)alkyl, (C1-C50)alkoxy, halo(C1-C50)alkyl, (C3-C50)cycloalkyl, (C6-C30)aryl, (C6-C30)aryloxy, (C1-C50)alkyl(C6-C30)aryloxy, (C6-C30)ar(C1-C50)alkyl, ((C1-C50)alkyl(C6-C30)aryl)(C1-C50)alkyl, —NR^{a}R^{b}, or —SiR^{c}R^{d}R^{e};

R₄, R₅, R₁₀, R₁₁, and R₁₂ are independently of one another (C1-C50)alkyl, halo(C1-C50)alkyl, (C3 -C50)cycloalkyl, (C6-C30)aryl, (C6-C30)ar(C1-C50)alkyl, ((C1-C50)alkyl(C6-C30)aryl)(C1-C50)alkyl, —NR^{a}R^{b}, or —SiR^{c}R^{d}R^{e}, and R₁₁ and R₁₂ may be connected by (C4-C7)alkylene to form a ring;

R₆, R₇, R₈, and R₉ are independently of one another hydrogen, (C1-C50)alkyl, halo(C1-C50)alkyl, (C3-C50)cycloalkyl, (C1-C50)alkoxy, (C6-C30)aryl, (C6-C30)ar(C1-C50)alkyl, ((C1-C50)alkyl(C6-C30)aryl)(C1-C50)alkyl, (C6-C30)aryloxy, (C1-C50)alkyl(C6-C30)aryloxy, N-carbazolyl, —NR^{a}R^{b}, or —SiR^{c}R^{d}R^{e}, or may be connected by (C1-C5)alkylene with an adjacent substituent to form a ring, and one or more —CH₂— of the alkylene may be substituted by a heteroatom selected from —O—, —S—, and —NR— and the alkylene may be further substituted by (C1-C50)alkyl;

the aryl of R₁ to R₁₂ may be further substituted by one or more substituents selected from the group consisting of (C1-C50)alkyl, halo(C1-C50)alkyl, (C1-C50)alkoxy, (C6-C30)aryloxy, (C6-C30)aryl, (C1-C50)alkyl(C6-C30)aryl, and (C6-C30)ar(C1-C50)alkyl;

R′ and R^{a} to R^{e} are independently of one another (C1-C50)alkyl or (C6-C30)aryl; and

X₁ and X₂ are independently of each other halogen, (C1-C50)alkyl, (C2-C50)alkenyl, (C3-C50)cycloalkyl, (C6-C30)aryl, (C6-C30)ar(C1-C50)alkyl, ((C1-C50)alkyl(C6-C30)aryl)(C1-C50)alkyl, (C1-C50)alkoxy, (C6-C30)aryloxy, (C1-C50)alkyl(C6-C30)aryloxy, (C1-C50)alkoxy(C6-C30)aryloxy, (C1-C50)alkylidene, or an anionic or double anionic ligand having 60 or less atoms containing N, P, O, S, Si, a halogen, and the like except hydrogen, but when one of X₁ or X₂ is the double anionic ligand, the other one is neglected.

More specifically, as the single active site metallocene catalyst, those described in Korean Patent Registration Publication No. 10-1212637 B1 and the like may be used.

In an exemplary embodiment of the present disclosure, a cocatalyst, a solvent, and the like may be further used in addition to the single active site metallocene catalyst.

The cocatalyst is not limited as long as it is commonly used in the art; however, specifically for example, the cocatalyst may include any one or a mixture of two or more selected from boron compounds and aluminum compounds.

A specific example which may be used as the aluminum compound may be any one or a mixture of two or more selected from methylaluminoxane, modified methylaluminoxane, and tetraisobutylaluminoxane as an aluminoxane compound; trialkylaluminum including trimethylaluminum, triethylaluminum, tripropylaluminum, triisobutylaluminum, and trihexylaluminum as an example of an organic aluminum compound; dialkylaluminumchloride including dimethylaluminum chloride, diethylaluminum chloride, dipropylaluminum chloride, diisobutylaluminum chloride, and dihexylaluminum chloride; alkylaluminum dichloride including methylaluminum dichloride, ethylaluminum dichloride, propylaluminum dichloride, isobutylaluminum dichloride, and hexylaluminum dichloride; dialkylaluminum hydride including dimethylaluminum hydride, diethylaluminum hydride, dipropylaluminum hydride, diisobutylaluminum hydride, and dihexylaluminum hydride, and the like.

In an exemplary embodiment of the present disclosure, the aluminum compound may be one or a mixture of two or more selected from alkylaluminoxane compounds or trialkylaluminum, or any one or a mixture of two or more selected from methylaluminoxane, modified methylaluminoxane, tetraisobutylaluminoxane, trimethylaluminum, triethylaluminum, trioctylaluminum, triisobutylaluminum, and the like.

A specific example of the boron-based cocatalyst may include tris(pentafluorophenyl)borane, tris(2,3,5,6-tetrafluorophenyl)borane, tris(2,3,4,5 -tetrafluorophenyl)borane, tris(3,4,5 -trifluorophenyl)borane, tris(2,3,4-trifluorophenyl)borane, phenylbis(pentafluorophenyl)borane, tetrakis(pentafluorophenyl)borate, tetrakis(2,3,5,6-tetrafluorophenyl)borate, tetrakis(2,3,4,5-tetrafluorophenyl)borate, tetrakis(3,4,5,6-tetrafluorophenyl)borate, tetrakis(2,2,4-trifluorophenyl)borate, phenylbis(pentafluorophenyl)borate, or tetrakis(3,5-bistrifluoromethylphenyl)borate. In addition, a specific combination examples thereof may include ferrocenium tetrakis(pentafluorophenyl)borate, 1,1′-dimethylferrocenium tetrakis(pentafluorophenyl)borate, tetrakis(pentafluorophenyl)borate, triphenylmethylinium tetrakis(pentafluorophenyl)borate, triphenylmethylinium tetrakis(3,5-bistrifluoromethylphenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(n-butyl)ammonium tetrakis(3,5-bistrifluoromethylphenyl)borate, N,N-dimethylanilinium tetrakis(pentafluorophenyl)borate, N,N-diethylanilinium tetrakis(pentafluorophenyl)borate, N,N-ditetradecylanilinium tetrakis(pentafluorophenyl)borate N,N-dihexadecylanilinium tetrakis(pentafluorophenyl)borate N,N-dioctadecylanilinium tetrakis(pentafluorophenyl)borate, N,N-2,4,6-pentamethylanilinium tetrakis(pentafluorophenyl)borate, dicyclohexylammonium tetrakis(pentafluorophenyl)borate, triphenylphosphonium tetrakis(pentafluorophenyl)borate, tri(methylphenyl)phosphonium tetrakis(pentafluorophenyl)borate, or tri(dimethylphenyl)phosphonium tetrakis(pentafluorophenyl)borate, and the most preferred one among these is N,N-dimethyl anilinium tetrakis(pentafluorophenyl)borate, triphenylmethylinium tetrakis(pentafluorophenyl)borate, N,N-ditetradecylanilinium tetrakis(pentafluorophenyl)borate N,N-dihexadecylanilinium tetrakis(pentafluorophenyl)borate N,N-dioctadecylanilinium tetrakis(pentafluorophenyl)borate, or tris(pentafluoro)borane.

Meanwhile, the cocatalyst may serve as a scavenger which removes impurities acting as a poison to the catalyst in the reactant.

According to an exemplary embodiment of the present disclosure, the ultra-low viscosity ethylene-butene copolymer may have a shear adhesion failure temperature (SAFT) of 70° C. or higher. Specifically, the shear adhesion failure temperature (SAFT) may be 70 to 100° C.

As described above, the ultra-low viscosity ethylene-butene copolymer may have a high shear adhesion failure temperature and secure thermal resistance as compared with the conventional ethylene-octene copolymer having the same density.

Moreover, the ultra-low viscosity ethylene-butene copolymer may represent a significantly low melting point as compared with the conventional ethylene-octene copolymer, even in the case of being prepared with a high density, and may be processed at a low processing temperature, thereby implementing rapid adhesion.

That is, as described above, though the ultra-low viscosity ethylene-butene copolymer has a physical property of the copolymer itself of a low melting point, it has an excellent shear adhesion failure temperature, and thus, when provided as a composition for a hot-melt adhesive, both improved adhesive strength and cohesiveness may be secured.

According to an exemplary embodiment of the present disclosure, the ultra-low viscosity ethylene-butene copolymer may be for a hot-melt adhesive. In the case of the hot-melt adhesive, the physical properties are largely dependent on the melting point, the density, the molecular weight, and the like of a base resin included therein. Thus, the ultra-low viscosity ethylene-butene copolymer according to the present disclosure which satisfies both a certain density and a melting point has a low processing temperature with a low melting point and may secure excellent thermal resistance with an excellent shear adhesion failure temperature, and thus, is excellent for use in a hot-melt adhesive.

Another embodiment of the present disclosure is a composition for a hot-melt adhesive includes: an ultra-low viscosity ethylene-butene copolymer having a density of 0.870 to 0.900 g/cm³ and a melting point of 63 to 90° C., a tackifier, and a wax.

The composition for a hot-melt adhesive according to the present disclosure provides a low processing temperature, may implement high shear adhesion failure temperature and peel adhesion failure temperature by a combination of the ultra-low viscosity ethylene-butene copolymer according to the present disclosure, a tackifier, and a wax, and may secure excellent thermal resistance.

Furthermore, the composition for a hot-melt adhesive according to the present disclosure has excellent thermal resistance, adhesiveness, and cohesiveness as compared with the composition for a hot-melt adhesive including the conventional ethylene-octene copolymer having the same density and may have a lower butene content than an octene content in the same base resin content, and thus, is excellent in terms of costs and productivity.

According to an exemplary embodiment of the present disclosure, the tackifier may improve initial wettability and adhesiveness upon adhesion and is used for improving processability, and is not particularly limited as long as it is commonly used in the hot-melt adhesive, but for example, may be any one or a mixture of two or more selected from rosin-based resins, terpene-based resins, coumarone-indene-based resins, petroleum-based resins, and the like. Specifically, the rosin-based resin may be any one or a mixture of two or more selected from natural rosins selected from gum rosin, wood rosin, tall oil rosin, distilled rosin, hydrogenated rosin, dimerized rosin, resinate, polymerized rosin, and the like; modified rosins; or esterified products thereof; and the like. In addition, the terpene resin may be any one or a mixture of two or more selected from copolymers and terpolymers of natural terpene such as styrene/terpene or alpha methyl styrene/terpene; a polyterpene resin; or a phenol modified terpene resin, hydrogenated derivatives thereof, and the like. In addition, the petroleum resin may be any one, a mixture of two or more, or a copolymer thereof selected from aliphatic hydrocarbon resins, cycloaliphatic hydrocarbon resins, aromatic hydrocarbon resins, aromatic modified aliphatic hydrocarbon resins, hydrogenated hydrocarbon resins, and the like. In addition, the petroleum resin may be any one or a mixture of two or more selected from hydrocarbon resins having 4 to 10 carbon atoms, specifically, C5 aliphatic resins, C9 aromatic resins, C5/C9 aliphatic/aromatic copolymer resin, and the like.

The tackifier may have further improved adhesiveness and also may express an excellent effect as the composition for a hot-melt adhesive with excellent adhesiveness with a substrate to be applied, when mixed with the ultra-low viscosity ethylene-butene copolymer and a wax to be provided as the composition for a hot-melt adhesive.

According to an exemplary embodiment of the present disclosure, the wax promotes crystallization and a curing speed, and is not particularly limited as long as it is commonly used in the hot-melt adhesive, but, specifically, for example, may be any one or a mixture of two or more selected from a paraffin wax, a polyolefin wax, a Fischer-Tropsch wax, a petroleum wax, a synthetic wax, a mineral wax, a vegetable wax, a microcrystalline wax, an ethylene vinyl acetate wax, a slack wax, an ethylene acrylic acid copolymer wax, and the like.

When the wax is mixed with the ultra-low viscosity ethylene-butene copolymer and the tackifier to provide the composition for a hot-melt adhesive, excellent processability and excellent thermal stability may be secured.

According to an exemplary embodiment of the present disclosure, the composition for a hot-melt adhesive may include 25 to 50 wt % of the ultra-low viscosity ethylene-butene copolymer, 20 to 45 wt % of the tackifier, and 20 to 40 wt % of the wax, with respect to the total weight. In some embodiments, 25 to 45 wt % of the ultra-low viscosity ethylene-butene copolymer, 20 to 45 wt % of the tackifier, and 20 to 40 wt % of the wax may be included, or 25 to 40 wt % of the ultra-low viscosity ethylene-butene copolymer, 20 to 40 wt % of the tackifier, and 20 to 35 wt % of the wax may be included. When the composition for a hot-melt adhesive includes the component at the contents described above, a high shear adhesion failure temperature and a peel adhesion failure temperature may be implemented and both excellent cohesiveness and adhesive strength may be secured.

According to an exemplary embodiment of the present disclosure, the ultra-low viscosity ethylene-butene copolymer of the composition for a hot-melt adhesive may have a viscosity of 6,000 to 20,000 cP as measured at 177° C. In some embodiments, the viscosity may be 6,000 to 18,000 cP as measured at 177° C. By including the ultra-low viscosity ethylene-butene copolymer having a low viscosity as described above, melting at a low processing temperature is possible, and decomposition, carbonization, gelation, adhesive strength loss, and the like may be prevented. Moreover, excellent thermal resistance may be secured.

According to an exemplary embodiment of the present disclosure, the ultra-low viscosity ethylene-butene copolymer of the composition for a hot-melt adhesive may be prepared by contacting a catalyst, a cocatalyst, ethylene, and butene in the presence of an appropriate organic solvent. Here, the catalyst and cocatalyst components may be added to a reactor separately, or each component may be mixed previously and added to a reactor, and mixing conditions such as an addition order, a temperature, or concentration are not particularly limited.

According to an exemplary embodiment of the present disclosure, the ultra-low viscosity ethylene-butene copolymer of the composition for a hot-melt adhesive may be polymerized in the presence of a single active site metallocene catalyst as a catalyst. The single active site metallocene catalyst is a homogeneous catalyst having a single catalytic active site, and may produce an ethylene-based copolymer having a narrow molecular weight distribution and being uniform as compared with a Ziegler-Natta catalyst. In addition, the ultra-low viscosity ethylene-butene copolymer is polymerized under the single active site metallocene catalyst, thereby producing a copolymer which may satisfy the melting point and the density to be desired. Thus, the physical properties to be desired in the present disclosure may be achieved.

The cocatalyst and the organic solvent are as described in the description of the ultra-low viscosity ethylene-butene copolymer, and thus, the description thereof will be omitted.

The ultra-low viscosity ethylene-butene copolymer of the composition for a hot-melt adhesive according to an exemplary embodiment of the present disclosure may have a butene content of 10 to 30 wt %. In some embodiments, the butene content may be 10 to 28 wt %. As described above, by having the butene content, excellent thermal resistance may be secured and excellent adhesiveness with a substrate may be provided as the composition for a hot-melt adhesive.

The composition for a hot-melt adhesive according to an exemplary embodiment of the present disclosure may further include an antioxidant. For example, the antioxidant is not particularly limited, but may be any one or a mixture thereof selected from phenol-based antioxidants, phosphite-based antioxidants, sulfur-based antioxidants, hindered amine-based antioxidants, and the like.

Specifically, the phenol-based antioxidant may be any one or more selected from 1,3,5-tris(3′,5′-di-t-butyl-4′-hydroxybenzyl)isocyanuric acid, 1,1,3-tris(2-methyl-4-hydroxy-5-t-butylphenyebutane, 3-(4′-hydroxy-3′,5′-di-t-butylphenyl)propionic acid-n-octadecyl, 3-(4′-hydroxy-3′,5′-di-t-butylphenyl)propionic acid-n-octadecyl, 3,9-bis{2-[3-(3-t-butyl-4-hydroxy-5-methylphenyl)propionyloxy]-1,1-dimethylethyl}2,4,8,10-tetraoxaspiro[5.5]undecane, 2-t-butyl-4-methoxyphenol, 3-t-butyl-4-methoxyphenol, 2,6-di-t-butyl-4-ethylphenol, 2,2′-methylene-bis(4-methyl-6-t-butylphenol), 4,4′-thiobis-(3-methyl-6-t-butylphenol), 4,4′-butylidenebis(3-methyl-6-t-butylphenol), 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, and the like.

The phosphite-based antioxidant may be any one or more selected from triphenylphosphite, diphenylisodecylphosphite, phenyldiisodecylphosphite, 4,4′-butylidene-bis(3-methyl-6-t-butylphenylditridecyl)phosphite, cyclic neopentanetetraylbis(nonylphenyl)phosphite, cyclic neopentanetetraylbis(dinonylphenyl)phosphite, cyclic neopentanetetrayltris(nonylphenyl)phosphite, cyclic neopentanetetrayltris(dinonylphenyl)phosphite, 10-(2,5-dihydroxyphenyl)-10H-9-oxa-10-phosphaphenanthrene-10-oxide, 2,2-methylenebis(4,6-di-t-butylphenyl)octylphosphite, diisodecylpentaerythritol, and tris(2,4-di-t-butylphenyl)phosphite, and the like.

The sulfur-based antioxidant may be any one or two or more selected from tetrakis [methylene-3-(dodecylthio)propionate]methane, dilauryl3,3′-thiodipropionate, distearyl3,3′-thiodipropionate, N-cyclohexylthiophthalimide, N-n-butylbenzenesulfonamide, and the like.

The hindered amine-based antioxidant may be any one or more selected from bis(2,2,6,6-tetramethyl-4-piperidyesebacate, bis(1,2,2,6,6-pentamethyl-4-piperidyl)sebacate, 3-dodecyl-1-(2,2,6,6-tetramethyl-4-piperidyl)pyrrolidine-2,5-dione, N-methyl-3-dodecyl-1-(2,2,6,6-tetramethyl-4-piperidyl)pyrrolidine-2,5-dione, N-acetyl-3-dodecyl-1-(2,2,6,6-tetramethyl-4-piperidyl)pyrrolidine-2,5-dione, poly({6-(1,1,3,3-tetramethylbutyl)imino-1,3,5-triazine-2,4-diyl}{(2,2,6,6-tetramethyl-4-piperidyl)imino}hexamethylene {(2,2,6,6-tetramethyl-4-piperidyl)imino}), and the like, but is not limited thereto.

According to an exemplary embodiment of the present disclosure, the antioxidant may be further included at 0.01 to 5 wt %, or 0.01 to 2 wt %, or 0.1 to 1 wt %, based on the total weight of the composition for a hot-melt adhesive, but is not limited thereto.

According to an exemplary embodiment of the present disclosure, the composition for a hot-melt adhesive may have a shear adhesion failure temperature (SAFT) of 95° C. or higher. In some embodiments, the shear adhesion failure temperature (SAFT) may be 95° C. or higher and the peel adhesion failure temperature (PAFT) may be 45° C. or higher. Specifically, the shear adhesion failure temperature (SAFT) may be 95 to 110° C. and the peel adhesion failure temperature (PAFT) may be 45 to 70° C. In some embodiments, the shear adhesion failure temperature (SAFT) may be 96 to 110° C. and the peel adhesion failure temperature (PAFT) may be 47 to 70° C.

In some embodiments, according to an exemplary embodiment of the present disclosure, the composition for a hot-melt adhesive may satisfy the following Relation 1 or 2, or the composition for a hot-melt adhesive may satisfy both Relations 1 and 2:

Tₐ−T_{c}≥24 Relation 1

T_{b}−T_{c}≥−24 Relation 2

wherein

Tₐ is a shear adhesion failure temperature (° C.) of the composition for a hot-melt adhesive, T_{b} is a peel adhesion failure temperature (° C.) of the composition for a hot-melt adhesive, and T_{c} is a melting point (° C.) of the ultra-low viscosity ethylene-butene copolymer. Specifically, Relation 1 may satisfy more than 25 to 50, or 26 to 50. Relation 2 may satisfy −24 to 0.

The composition for a hot-melt adhesive according to the present disclosure may have high shear adhesion failure temperature and peel adhesion failure temperature as described above, thereby securing excellent thermal resistance.

Furthermore, even though the ultra-low viscosity ethylene-butene copolymer is prepared with a high density as compared with the conventional ethylene-octene copolymer, the composition for a hot-melt adhesive according to the present disclosure may have a low melting point, and even in that case, may implement excellent shear adhesion failure temperature, and thus, may secure both further improved adhesive strength and cohesiveness.

Hereinafter, the preferred Examples and Comparative Examples of the present disclosure will be described. However, the following Examples are only a preferred exemplary embodiment of the present disclosure, and the present disclosure is not limited thereto.

### Measurement Method of Physical Properties

### 1. 1-Butene or 1-Octene Content

The content was analyzed using ¹³C-nuclear magnetic resonance (NMR) and measured using ¹³C-NMR spectroscopy.

### 2. Molecular Weight and Molecular Weight Distribution

Specimens (copolymer) prepared from the Examples and the Comparative Examples were measured using gel permeation chromatography (GPC).

As a solvent, 1,2,4-trichlorobenzene was used. The measurement was performed at 160° C., and separation and analysis were performed with three PL gel columns connected in series. As a standard for calculating a relative molecular weight, a polystyrene standard having a molecular weight of 580 to 6,870,000 and a Mark Houwink constant (K,α) of polyethylene was used.

### 3. Density

Specimens (copolymer, pellet) prepared from the Examples and the Comparative Examples were dried at 100° C. for 1 hour, the dried specimens were produced into a sheet having a thickness of 3 mm in a press mold at 105° C., and 2-3 g was taken to perform measurement with an autodensimeter in accordance with ASTM D792. (Equipment was manufactured from Toyoseiki.)

### 4. Converted Melt Index (MI)

In accordance with ASTM D1238, the measurement was performed with a load of 2.16 kg at 100° C., a weight (g) of a polymer which was melted for 10 minutes and discharged was calculated, and the weight was converted into MI at 190° C. in accordance with an empirical formula. The empirical formula for conversion is as follows:

Converted MI (190° C./2.16 kg)=MI (measurement value at 100° C./2.16 kg)×9.96+30

### 5. Viscosity

A melt viscosity at 177° C. was measured using a viscometer and Thermosel manufactured by Brookfield. (Model name DV2T)

### 6. Shear Adhesion Failure Temperature (SAFT) and Peel Adhesion Failure Temperature (PAFT)

Specimen preparation: A copolymer or a composition for a hot-melt adhesive was uniformly applied to an interface between two sheets of kraft of 2.5 cm×2.5 cm by reciprocating three times using a roller and was pressed for 24 hours to prepare a specimen.

Shear adhesion failure temperature: The specimens (copolymers or compositions for a hot-melt adhesive) prepared from the Examples and the Comparative Examples were hung in a vertical (perpendicular) direction, a weight of 500 g was hung, the temperature was raised at a rate of 0.5° C./min, and a temperature at which the specimen was separated and failed was measured.

Peel adhesion failure temperature: The specimens (copolymers) prepared from the Examples and the Comparative Examples were hung in a horizontal direction (peel-mode), a weight of 100 g was hung, the temperature was raised at a rate of 0.5° C./min, and a temperature at which the specimen was separated and failed was measured.

### 7. Melting Point (Tm), Using DSC (Using a General DSC Measurement Method)

A differential scanning calorimeter manufactured by Mettler was used.

The temperature was changed by 10° C. per minute in the range of −100° C. to 200° C. under a nitrogen atmosphere, and a Tm peak of a 2^{nd} scan was measured as the melting point.

### EXAMPLES 1-6

Copolymerization of ethylene and 1-butene was carried out using continuous polymerization equipment, as follows. Catalyst A, Catalyst B, Catalyst C, or Catalyst D were used as a single active site catalyst as shown in Table 1, methylcyclohexane was used as a solvent, and a catalyst amount used is as shown in the following Table 1. Ti represents a catalyst, Al represents triisobutylaluminum, and B represents N,N-dioctadecylanilinium tetrakis(pentafluorophenyl)borate which is the synthesized in Preparation Example 1, respectively. The catalyst was dissolved xylene at a concentration of 0.5 g/L and injected, triisobutylaluminum was injected at a concentration of 1.6 g/L to methylcyclohexane, N,N-dioxtadecylanilinium tetrakis(pentafluorophenyl)borate was dissolved in xylene at a concentration of 1.0 g/L and injected, and 1-butene was used as a comonomer to perform synthesis. The conditions and the results are described in the following Table 1, and the physical properties of the copolymer were measured and are shown in the following Table 2.

### COMPARATIVE EXAMPLE 1

### Copolymerization of Ethylene and 1-Octene by Continuous Solution Process

Copolymerization of ethylene and 1-octene was carried out using continuous polymerization equipment, as follows. Catalyst B was used as a single active site catalyst, and methylcyclohexane was used as a solvent, and an amount of the catalyst used is as shown in the following Table 1. Ti represents a catalyst, Al represents triisobutylaluminum, and B represents N,N-dioctadecylanilinium tetrakis(pentafluorophenyl)borate which is the synthesized in Preparation Example 1, respectively. The catalyst was dissolved xylene at a concentration of 0.5 g/L and injected, triisobutylaluminum was injected at a concentration of 2.4 g/L to methylcyclohexane, N,N-dioxtadecylanilinium tetrakis(pentafluorophenyl)borate was dissolved in methylcyclohexane at a concentration of 0.375 g/L and injected, and 1-octene was used as a comonomer to perform synthesis. The conditions and the results are described in the following Table 1, and the physical properties of the copolymer were measured and are shown in the following Table 2.

### COMPARATIVE EXAMPLE 2

Dow GA1950 (ethylene-1-octene copolymer) was used and the physical properties were measured and are shown in the following Table 2.

### COMPARATIVE EXAMPLE 3

Dow GA1900 (ethylene-1-octene copolymer) was used and the physical properties were measured and are shown in the following Table 2.

TABLE 1

| | | Exam- | Exam- | Exam- | Exam- | Exam- | Exam- | Comparative |
|---|---|---|---|---|---|---|---|---|
| | | ple 1 | ple 2 | ple 3 | ple 4 | ple 5 | ple 6 | Example 1 |
| Polymer- | Single active | Catalyst | Catalyst | Catalyst | Catalyst | Catalyst | Catalyst | Catalyst |
| ization | site catalyst | A | B | A | B | C | D | B |
| conditions | Total solution | 180 | 201 | 178 | 201 | 201 | 180 | 154 |
| | flow rate | | | | | | | |
| | (kg/h) | | | | | | | |
| | Amount of | 10.5% | 9.1% | 10.6% | 9.1% | 9.1% | 10.5% | 12.6% |
| | ethylene | | | | | | | |
| | added (wt %) | | | | | | | |
| | Added mole | 0.90 | 0.77 | 0.74 | 0.71 | 0.75 | 0.73 | 1.29 |
| | ratio of 1- | | | | | | | |
| | butene (or 1- | | | | | | | |
| | octene) to | | | | | | | |
| | ethylene | | | | | | | |
| | (1-C4 (or | | | | | | | |
| | 1-C8)/C2) | | | | | | | |
| | Amount of Ti | 2.7 | 2.4 | 2.5 | 2.4 | 2.5 | 2.8 | 3.5 |
| | added | | | | | | | |
| | (μmol/kg) | | | | | | | |
| | Al/Ti ratio | 16.9 | 17.8 | 17.2 | 15.8 | 16.5 | 17.3 | 9.2 |
| | B/Ti ratio | 3.5 | 3.5 | 3.8 | 3.4 | 3.5 | 3.4 | 3.1 |
| | Reaction | 150 | 135 | 150 | 136 | 135 | 150 | 135 |
| | temperature | | | | | | | |
| | (° C.) | | | | | | | |

Ti: means Ti in the single active site catalyst (Preparation Example 1)
Al: means Al of an aluminum compound as the cocatalyst, that is, triisobutylaluminum.
B: means B of N,N-dioctadecylanilinium tetrakis(pentafluorophenyl)borate or trityl tetrakis(pentafluorophenyl)borate as the catalyst activator
Total solution flow rate: solvent + ethylene + octene flow rate (kg/hr)
Al/Ti and B/Ti mean a ratio between elements.
Catalyst A: (t-butylamido)-1,1-dimethyl(9,9-ditetradecyl-1,2-dimethyl-3,9-hydrocyclopenta[b]fluorene-3-yl)silanetitanium(IV)dimethyl
Catalyst B: a mixture of (t-butylamido)dimethyl(9,9-ditetradecyl-2-methyl-3,9-dihydrocyclopenta[b]fluorene-3-yl)silanetitanium(IV)dimethyl and (t-butylamido)dimethyl(9,9-ditetradecyl-2-methyl-1,9-dihydrocyclopenta[b]fluorene-1-yl)silanetitanium(IV)dimethyl
Catalyst C: a mixture of (t-butylamido)dimethyl(9,9-hexyl-2-methyl-3,9-dihydrocyclopenta[b]fluorene-3-yl)silanetitanium(IV)dimethyl and (t-butylamido)dimethyl(9,9-hexyl-2-methyl-1,9-dihydrocyclopenta[b]fluorene-1-yl)silanetitanium(IV)dimethyl
Catalyst D: (t-butylamido)-1,1-dimethyl(1,2,9,9-tetramethyl-3,9-hydrocyclopenta[b]fluorene-3-yl)silanetitanium(IV)dimethyl

TABLE 2

| | | Butene or | | | | | |
|---|---|---|---|---|---|---|---|
| | | octene | Converted | Viscosity | Melting | SAF | |
| | Density | content | Melt index | (177° C., | point | T | PAFT |
| | (g/cm³) | (wt %) | (g/10 min) | CPS) | (° C.) | (° C.) | (° C.) |
| Example 1 | 0.874 | 24.1 | 540 | 15,500 | 63 | 70 | Room |
| | | | | | | | temperature |
| Example 2 | 0.875 | 23.9 | 460 | 17,800 | 70 | 73 | Room |
| | | | | | | | temperature |
| Example3 | 0.883 | 20.3 | 440 | 18,400 | 75 | 85 | Room |
| | | | | | | | temperature |
| Example 4 | 0.879 | 22.0 | 540 | 15,500 | 75 | 81 | Room |
| | | | | | | | temperature |
| Examples | 0.880 | 21.6 | 450 | 17,900 | 73 | 82 | Room |
| | | | | | | | temperature |
| Example 6 | 0.882 | 20.8 | 530 | 15,800 | 75 | 83 | Room |
| | | | | | | | temperature |
| Comparative | 0.874 | 29.6 | 450 | 18,100 | 78 | 77 | Room |
| Example 1 | | | | | | | temperature |
| Comparative | 0.874 | — | 500 | 17,000 | 71 | 77 | Room |
| Example 2 | | | | | | | temperature |
| Comparative | 0.870 | — | 1,000 | 8,200 | 67 | 70 | Room |
| Examples | | | | | | | temperature |

As shown in Table 2, it was confirmed that the ethylene-butene copolymer according to the present disclosure has a low melting point as compared with an ethylene-octene copolymer, but has a significantly improved shear adhesion failure temperature and excellent adhesiveness with a substrate. In addition, even in the case in which the butene content is decreased as compared with the octene content, with respect to the total weight of the copolymer, it was confirmed that excellent cohesiveness and adhesion was maintained. Thus, the ethylene-butene copolymer according to the present disclosure has excellent economic feasibility in terms of costs and productivity.

In addition, even in the case in which the copolymer was prepared at a high density as compared with Comparative Example 1, it was confirmed to have a low melting point and also a significantly improved shear adhesive strength.

### EXAMPLE 7

The ethylene-butene copolymer prepared in Example 1 was sufficiently melted at 150° C. and kneaded, a tackifier (Kolon Sukorez SU-120), a wax (Sasolwax H1), and an antioxidant (Irganox 1010) were further added, and mixing was performed to prepare a composition for a hot-melt adhesive.

Here, the added amounts of 34.5 wt % of the ethylene-butene copolymer, 35 wt % of the tackifier, 30 wt % of the wax, and 0.5 wt % of the antioxidant were mixed.

### EXAMPLE 8

The process was performed in the same manner as in Example 7, except that the ethylene-butene copolymer prepared in Example 2 was used.

### EXAMPLE 9

The process was performed in the same manner as in Example 7, except that the ethylene-butene copolymer prepared in Example 3 was used.

### EXAMPLE 10

The process was performed in the same manner as in Example 7, except that the ethylene-butene copolymer prepared in Example 4 was used.

### EXAMPLE 11

The process was performed in the same manner as in Example 7, except that the ethylene-butene copolymer prepared in Example 5 was used.

### EXAMPLE 12

The process was performed in the same manner as in Example 7, except that the ethylene-butene copolymer prepared in Example 6 was used.

### COMPARATIVE EXAMPLE 4

The process was performed in the same manner as in Example 7, except that the ethylene-octene copolymer prepared in Comparative Example 1 was used instead of the ethylene-butene copolymer.

### COMPARATIVE EXAMPLE 5

The process was performed in the same manner as in Example 7, except that the ethylene-octene copolymer prepared in Comparative Example 2 was used instead of the ethylene-butene copolymer.

### COMPARATIVE EXAMPLE 6

The process was performed in the same manner as in Example 7, except that the ethylene-octene copolymer prepared in Comparative Example 3 was used instead of the ethylene-butene copolymer.

The physical properties of the compositions for a hot-melt adhesive prepared in Examples 7 to 12 and Comparative Examples 4 to 6 were measured and are shown in the following Table 3.

TABLE 3

| | HMA | HMA | | |
|---|---|---|---|---|
| | SAFT | PAFT | | |
| | (° C.) | (° C.) | Relation 1 | Relation 2 |
| Example 7 | 96 | 59 | 33 | −4 |
| Example 8 | 95 | 50 | 25 | −20 |
| Example 9 | 102 | 62 | 27 | −13 |
| Example 10 | 99 | 51 | 24 | −24 |
| Example 11 | 101 | 59 | 28 | −14 |
| Example 12 | 101 | 61 | 26 | −14 |
| Comparative | 94 | 54 | 16 | −24 |
| Example 4 | | | | |
| Comparative | 94 | 54 | 23 | −17 |
| Example 5 | | | | |
| Comparative | 90 | 53 | 23 | −14 |
| Example 6 | | | | |

As shown in the above Table 3, it was confirmed that the composition for a hot-melt adhesive according to the present disclosure has high shear adhesion failure temperature and peel adhesion failure temperature, implements excellent thermal resistance, and may secure both excellent cohesiveness and adhesive strength.

Therefore, the composition for a hot-melt adhesive according to the present disclosure includes the ethylene-butene copolymer according to the present disclosure, thereby having a low melting point as compared with the conventional ethylene-octene copolymer having the same density to be prepared at a low processing temperature, and also having a low melting point even in the case of being prepared at a high density as compared with the conventional ethylene-octene copolymer. Besides, it was confirmed that by including the ethylene-butene copolymer having a low melting point according to the present disclosure, the composition had significantly improved high shear adhesion failure temperature and peel adhesion failure temperature and was excellent as the hot-melt adhesive with excellent thermal stability.

Hereinabove, although the present disclosure has been described by the specific matters and specific exemplary embodiments, they have been provided only for assisting in the entire understanding of the present disclosure. Therefore, the present disclosure is not limited to the exemplary embodiments, and various modifications and changes may be made by those skilled in the art to which the present disclosure pertains from this description.

Therefore, the spirit of the present disclosure should not be limited to the above-described exemplary embodiments, and the following claims as well as all modified equally or equivalently to the claims are intended to fall within the scope and spirit of the disclosure.

### ADVANTAGEOUS EFFECTS

The ethylene-butene copolymer according to the present disclosure may be rapidly melted at a certain melting point or higher and may provide a low processing temperature with a significantly low viscosity.

In addition, the composition for a hot-melt adhesive according to the present disclosure includes the ethylene-butene copolymer, thereby having excellent thermal resistance with high shear adhesion failure temperature and peel adhesion failure temperature and securing both excellent cohesiveness and adhesive strength.

1. An ultra-low viscosity ethylene-butene copolymer which is a copolymer derived from ethylene and butene,
wherein the ultra-low viscosity ethylene-butene copolymer has a density of 0.874 to 0.900 g/cm³ and a melting point of 63 to 90° C.

2. The ultra-low viscosity ethylene-butene copolymer of claim 1, wherein the ultra-low viscosity ethylene-butene copolymer has a viscosity of 6,000 to 20,000 cP as measured at 177° C.

3. The ultra-low viscosity ethylene-butene copolymer of claim 1, wherein the ultra-low viscosity ethylene-butene copolymer is prepared by solution polymerization in the presence of a single active site metallocene catalyst.

4. The ultra-low viscosity ethylene-butene copolymer of claim 1, wherein the ultra-low viscosity ethylene-butene copolymer has a weight average molecular weight of 15,000 to 30,000 g/mol.

5. The ultra-low viscosity ethylene-butene copolymer of claim 1, wherein the ultra-low viscosity ethylene-butene copolymer has a shear adhesion failure temperature (SAFT) of 70° C. or higher.

6. The ultra-low viscosity ethylene-butene copolymer of claim 1, wherein the ultra-low viscosity ethylene-butene copolymer has a butene content of 10 to 30 wt %.

7. The ultra-low viscosity ethylene-butene copolymer of claim 1, wherein the ultra-low viscosity ethylene-butene copolymer is used for a hot-melt adhesive.

8. A composition for a hot-melt adhesive comprising: an ultra-low viscosity ethylene-butene copolymer having a density of 0.874 to 0.900 g/cm³ and a melting point of 63 to 90° C., a tackifier, and a wax.

9. The composition for a hot-melt adhesive of claim 8, wherein the composition for a hot-melt adhesive includes 25 to 50 wt % of the ultra-low viscosity ethylene-butene copolymer, 20 to 45 wt % of the tackifier, and 20 to 40 wt % of the wax.

10. The composition for a hot-melt adhesive of claim 8, wherein the ultra-low viscosity ethylene-butene copolymer has a viscosity of 6,000 to 20,000 cP as measured at 177° C.

11. The composition for a hot-melt adhesive of claim 8, wherein the ultra-low viscosity ethylene-butene copolymer is prepared by solution polymerization in the presence of a single active site metallocene catalyst.

12. The composition for a hot-melt adhesive of claim 8, wherein the ultra-low viscosity ethylene-butene copolymer has a butene content of 10 to 30 wt %.

13. The composition for a hot-melt adhesive of claim 8, further comprising: an antioxidant.

14. The composition for a hot-melt adhesive of claim 8, wherein the composition for a hot-melt adhesive has a shear adhesion failure temperature (SAFT) of 95° C. or higher and a peel adhesion failure temperature (PAFT) of 45° C. or higher.

15. The composition for a hot-melt adhesive of claim 8, wherein the composition for a hot-melt adhesive satisfies the following Relations 1 and 2:
Tₐ−T_{c}≥24 Relation 1
T_{b}−T_{c}≥−24 Relation 2
wherein
Tₐ is a shear adhesion failure temperature (° C.) of the composition for a hot-melt adhesive, T_{b} is a peel adhesion failure temperature (° C.) of the composition for a hot-melt adhesive, and T_{c} is a melting point (° C.) of the ultra-low viscosity ethylene-butene copolymer.
